(19) United States
(12) Patent Application Publication
(10) Pub. No.: US 2008/0172430 A1
(43) Pub. Date: Jul. 17, 2008

(54) Fragmentation Compression Management

(76) Inventor: Andrew Thomas Thorstensen, Rochester, MN (US)

Correspondence Address: IBM CORPORATION (SS/ROC);c/o STREETS & STEELE, 13831 NORTHWEST FREEWAY, SUITE 355, HOUSTON, TX, 77040, US

(21) Appl. No.: 11/622,076

(22) Filed: Jan. 11, 2007

(51) Int. Cl. G06F 12/00

(52) U.S. Cl. 707/206; 707/E17.002; 707/E17.01

(57) ABSTRACT

A method of managing data fragments on computer readable storage media includes identifying an identical data segment within both of first and second data files, establishing a single instance of the identical data segment as a shared data fragment, modifying file headers associated with the first and second data files so that each file header associates with the shared data fragment, and reclaiming storage space that contains a redundant instance of the identical data segment. A data file or data fragment may be divided or further divided into data fragments if the file or fragment is identified as having a data segment that is identical to a data segment in a different data file or fragment. The method should require that amount of identical data reclaimed is greater than the amount of new header information stored with each fragment.

### BACKGROUND OF THE INVENTION

1. Field of the Invention

The present invention relates to compression management of computer readable information.

2. Description of the Related Art

Systems are finding an increasing need for storage. Typically, much of the information stored on these systems is redundant. For instance, if a large file is stored in one location and then is copied to another folder on the disk, the storage system will write the file to the other location (thus taking up twice as much space on the disk). This can be extremely wasteful as the file is identical to the original. The user may even make changes to a file and save both the original and modified versions of the file despite the large similarities that may exist between the files. Since each version may take up about the same amount of storage space, retention of multiple file versions can quickly consume large amounts of storage space.

In order to combat these increasing storage requirements, disk drives have gotten larger and new compression methods have been introduced. The newer compression methods typically require a large amount of memory and processing time in order to decompress files. Furthermore, large disk drives can be expensive and may require upgrades to other hardware parts in order to accommodate the added disks. This approach can be expensive to the end user.

Still further, attempts at implementing organizational policies directed at limiting the number and types of files retained on a computer system have not proven to be practical. Manual file management by the computer user or system administrator is extremely time consuming and may result in the loss of useful files. Although the cost of storing unnecessary files may become significant, the productive use of employee time and the retention of valuable work product can easily be more important to the success of an organization.

Therefore, there is a need for an improved method of data compression that would enable disk space to be reclaimed over time without a significant impact on system performance. It would be desirable if the method could be completely automated and incorporated directly into the file system so as to have only a negligible impact on system performance.

### SUMMARY OF THE INVENTION

The present invention provides a method and computer program product for managing data fragments. The method includes identifying identical instances of a data segment within both of first and second data files; establishing one of the identical instances as a shared data fragment; modifying file headers of the first and second data files so that each file header associates with the shared data fragment and does not associate with a redundant instance of the data segment, and reclaiming media storage space occupied by any data segment that is no longer associated with a file header. In one embodiment, a copy command may be executed by establishing the second data file with a file header that points to the same data fragments as the first file header.

The method may further include identifying any unique data segment within either of the first and second data files; establishing each unique data segment as a dedicated data fragment; and modifying file headers associated with either of the first and second data files so that each file header points to any dedicated data fragment that is part of the associated data file.

In a preferred embodiment, the step of determining that first and second data files include an identical data segment and at least one unique data segment, further comprises the steps of: producing a data stream associated with each of the first and second data files, each data stream comprising the output of an algorithm that produces a representative bit for each of sequence of bytes in the data file; identifying portions of the data stream associated with the first data file containing a sequence of bits in common with the data stream associated with the second data file, wherein the sequence of bits exceeds a certain minimum sequence length; performing a bit-by-bit comparison of only those segments of the first and second data files that were used to produce the identical portions of the data streams; and then identifying an identical data segment as that segment of the first and second data files that are bit-by-bit identical. Further still, the step of identifying identical portions of the data stream may include an iterative process of comparing a search fragment against a candidate fragment, then advancing the position of the search fragment by one bit relative to the second candidate fragment. Preferably, it is determined whether the identical data segment has a length greater than a set point length, wherein the set point is a value calculated as a function of additional file header segment storage lengths necessary to accommodate reclaiming one of the identical data segments.

### BRIEF DESCRIPTION OF THE DRAWINGS

FIG. 1 is a schematic diagram of the data segments of first and second data files stored in accordance with the prior art.

FIGS. 2 through 7 are schematic diagrams of the data segments of first and second data files as the files are compared, identical segments are identified, headers are modified, and storage space is reclaimed.

FIG. 8 is a schematic diagram of a method of forming a comparison data stream.

FIG. 9 is a schematic diagram illustrating how the comparison data streams for two files are converted to snapshots for purpose of comparison.

FIGS. 10 through 14 are schematic diagrams that show a sequence of steps for comparing the two comparison data streams.

FIG. 15 is a schematic diagram of the identical portion of the data streams and the unique portions of the data streams in sequential relation to the shared identical portion.

FIG. 16 is a schematic diagram of a preferred arrangement for storing the unique fragments of two files in relation to a fragment shared by the two files.

### DETAILED DESCRIPTION

The present invention provides a method of managing data fragments on computer readable storage media. The method comprises the steps of identifying an identical data segment within both of first and second data files, establishing a single instance of the identical data segment as a shared data fragment, and modifying file headers associated with the first and second data files so that each file header points to the shared data fragment. This method enables the reclaiming of storage space that contains redundant data segments.

A data file may be divided into data fragments if the file is identified as having a data segment that is identical to a data segment in a different data file. Similarly, a data fragment may be divided into further data fragments if the data fragment is identified as having a data segment that is identical to a data segment in a different data segment.

Preferably, the identical data segments are only divided out of a file or fragment if division is beneficial to the overall computer system where the files are stored. It would never be beneficial to divide a file if the amount of identical data that could be reclaimed is not greater than the amount of new header information that must be stored with each fragment in order to accommodate the division. This situation would never be beneficial because there is no potential gain of storage space and the increased fragmentation would cause an incremental reduction in performance due to the greater number of disk seeks required to read the file. Accordingly, the fragmentation compression process is preferably only performed when it is “useful,” meaning that the benefits of the space gain on a storage media (by breaking out the segment into its own fragment is greater than the space) outweigh the resulting reduction in system performance.

For a system that is nearing its storage capacity, the method may determine that even a marginal reduction of storage space is “useful.” In order for to achieve a marginal reduction of storage space, the space gain on a storage media by reclaiming a redundant fragment must be greater than the space loss on the storage media created by the greater number of fragment headers. The minimum segment size (referred to herein as “the Omega value”) is preferably set to be at least four (4) times the storage space of creating a fragment header. The Omega value is preferably at least four times the storage space of creating a File Segment Header, because breaking a segment out of two input streams can create up to four new file segment headers. When the identical segment is found in the middle of two input streams, then segment headers for each of the first and second input streams will include a beginning fragment header, the shared fragment header, and the end fragment header. This holds true for the second input stream as well. Therefore, two streams which initially had only two fragments and two corresponding fragment headers will now have six file fragments and six corresponding fragment headers. The Omega value is most preferably even greater than a multiple of four, because of the marginal decrease in system performance with an increasing degree of segmentation. For example, it is reasonable that a system nearing its storage capacity would accept fragmentation if the gain is only 50 bytes. It should be recognized that whereas the Omega value has been described as a minimum multiple of the size of a fragment header, it is within the scope of the invention for the Omega value to be a minimum amount of storage space or some combination of both factors.

However, a system having a lot of disk space to spare would preferably put a greater emphasis on maintaining a high system performance than on achieving very small marginal gains of storage space. Accordingly, system performance may be kept high by increasing the Omega value so that the minimum size of a shared fragment will be larger, fewer fragments will be created, and fewer disk seeks will be required. However, Omega should not need to be too large as there are ways to reduce the increased disk seeks. For example, it is reasonable that a system with a lot of additional storage capacity would only accept fragmentation as being beneficial if the gain is greater than 1000 bytes. Accordingly, the method preferably monitors the available storage space on an ongoing basis in order to determine an appropriate Omega value for the current conditions of the system.

Each data file includes a file header that maintains an ordered list of the various data fragments that make up an entire file. When dividing out an identical data segment to form a shared fragment, the file headers of both files are modified to include new entries that point to the shared fragment.

A fragment manager may be created to handle the management of the data segments. The fragment manager would be responsible for carrying out the method of the invention. Accordingly, the fragment manager would manage the shared data fragments and release any data segment from memory when no file header points to that segment. The fragment manager would also examine fragments (or string of fragments) and would make the decision as to whether or not it would be advantageous to merge file fragments into a common file fragment.

Because the efficient storage of data is important but rarely urgent, the fragment manager could be implemented as a low priority process running in the background. For the newer processors with multiple cores (cell, PowerPC, etc . . . ) it could run on one of the separate cores and not utilize many system resources. If at any point another process requested control of the core, the fragment manager would pause itself and allow the new process to run. At no point in time would the fragment manager consume the resources for currently running processes. Also, with the advent of Native Command Queing, the fragment manager could queue disk requests along side the current process requests—further reducing total system impact.

The present method of managing fragments is particularly useful in applications where large portions of data may be identical. For example, the method may be used in a concurrent control system such that storing a new version of a file would cause the changes to be broken out into a new segment and the identical data (redundant to the original version of the file) would link to the shared file segment. In a digital video recording system, individual television shows may be recorded in separate files. However, if a segment of the files are identical, such as a commercial that occurred during more than one recorded show, then the files may be divided into fragments so that the commercials are stored in a shared fragment. Still further, any data in static files stored on a server or personal computer that is identified as being identical could be divided out into fragments in order to allow storage space to be reclaimed over time.

In order to quickly and efficiently identify identical data segments, one embodiment of the invention includes producing a Comparison Stream for each file. A suitable Comparison Stream facilitates a rough comparison of the similarity between two files without imposing the high processor load that would be associated with a full bit-by-bit comparison of every file. If segments of the Comparison Streams match, then the actual data segments may be similar, but it is not yet known whether the data segments are identical. Rather, after identifying identical comparison stream segments, it is then necessary to perform a bit-by-bit comparison of the original data segments.

Using the Comparison Streams as a rough comparison limits the amount of data that must be compared bit-by-bit. Preferably, the bit-by-bit comparison is only performed if the two comparison streams are found to have matching comparison stream segments that represent a data segment length that is greater than the Omega value. The bit-by-bit comparison is therefore much more efficient, because only identical comparison stream segments having a certain length will be further compared.

While the foregoing discussion has described the segmentation of a file and storage of those segments as separate fragments, it is also possible for the present invention to utilize new or existing fragments created in the normal course of storing data in a modern file system. Modern file systems may store segments of large files in data fragments across multiple portions of the storage media. If one of these fragments is identical to another fragment or a segment of a fragment, then modifying the file header to point to a shared fragment will media space previously storing a redundant copy to be reclaimed.

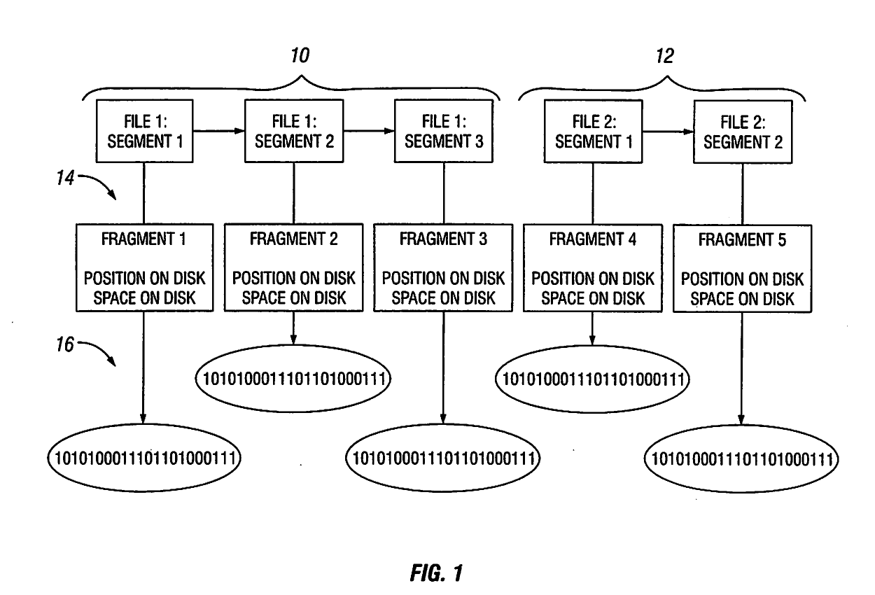

FIGS. 1 through 7 provide a detailed graphical representation of one embodiment of the present method of fragment management. Each of the Figures represents a step of the method and will be discussed separately below.

FIG. 1 is a schematic diagram of the data segments of first and second data files stored in accordance with the prior art. File 1 is shown with a file header 10 that includes information regarding Segment 1, Segment 2 and Segment 3, while File 2 is shown with a file header 12 that includes information regarding Segment 1 and Segment 2. Each of these five segments is shown as being stored as a separate fragment, wherein each fragment includes a fragment header 14 and the data fragment 16. The first file (File 1) header 10, the second file (File 2) header 12, the fragment headers 14 and the data fragments 16 are all stored on the media. However, the header information 10, 12, and 14 may be stored in the table of contents, whereas the data fragments 16 are usually stored in the area of the disk not consumed by the table of contents.

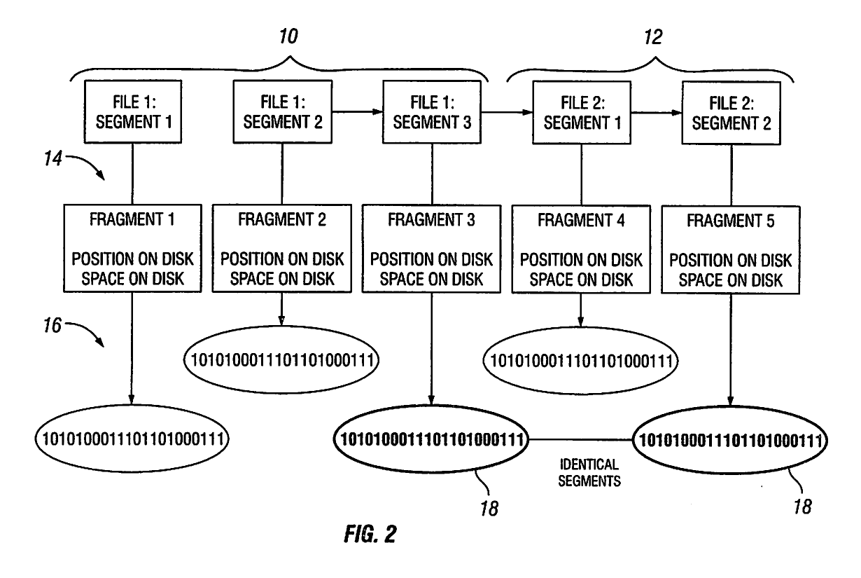

FIG. 2 is a schematic diagram of the data segments of first and second data files having identified two identical fragments 18, i.e. Fragment 3 and Fragment 5. This is preferably identified by analyzing comparison streams for each of the fragments, then performing a bit-by-bit comparison for segments of the comparison streams that match.

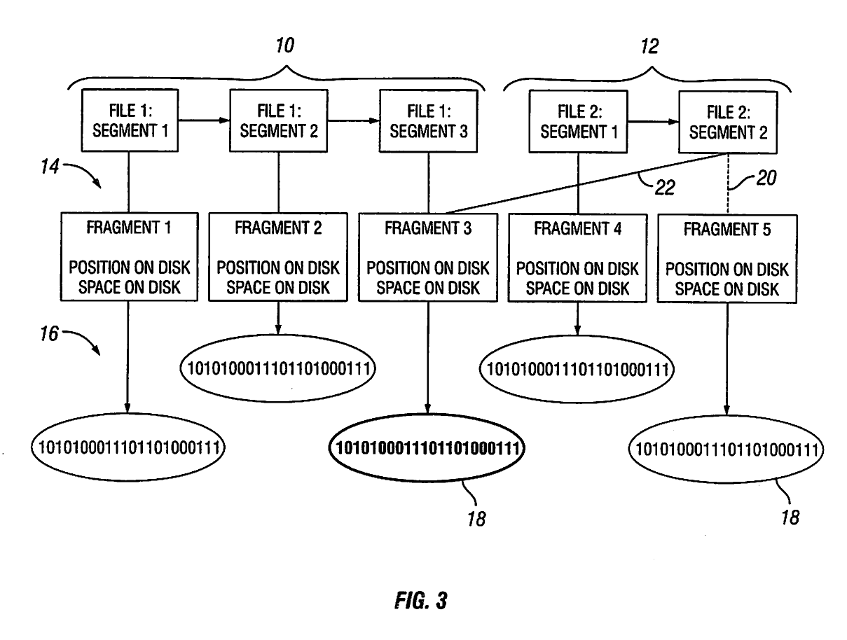

FIG. 3 is a schematic diagram of the data segments of first and second data files having modified the file header 12 of File 2 to point to Fragment 3 (rather than Fragment 5) to find the data of File 2, Segment 2. The old association between File 2, Segment 2 and Fragment 5, as illustrated by line or pointer 20, has been replaced by a new line or pointer 22. Fragment 3 is now considered to be a “shared fragment” in that there are two file segments, i.e., File 1, Segment 3 and File 2, Segment 2, that point to the same fragment. The Fragment Manager is responsible for modifying the headers to establish this re-association. Furthermore, the Fragment Manager must monitor both files and verify that neither file is being written to while it is modifying the fragments of this file. If the Fragment Manager is alerted that any of the fragments is being written to, then the Fragment Manager should not continue fragmenting the data because to do so would jeopardize the integrity of the file's segments.

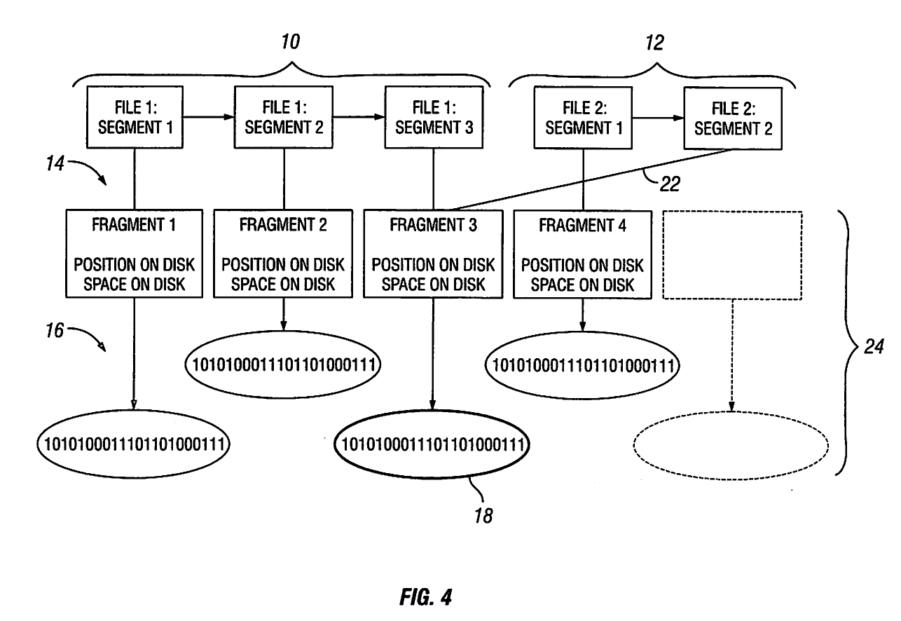

FIG. 4 is a schematic diagram of the data segments of first and second data files having reclaimed the storage space 24 previously occupied by Fragment 5 and its fragment header. Having reclaimed the storage space, much of the benefit of the invention has been realized.

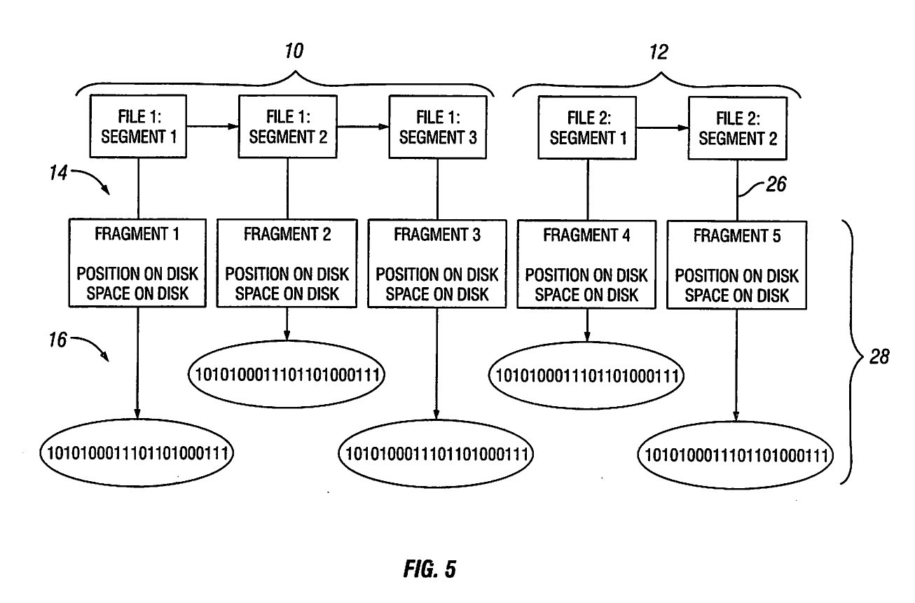

FIG. 5 is a schematic diagram of the data segments of first and second data files after the second data file has been rewritten to the storage media. Now, the file header 12 has broken all associations with the shared Fragment 3 and the file has been rewritten to the media as if it were a completely new file. Accordingly, the file header 12 for File 2 has again been modified in order for File 2, Segment 2 to establish a new association (as illustrated by the line or pointer 26) with a new Fragment 5 (shown at 28). The new Fragment 5′ was presumably formed by reading a copy of Fragment 3 into memory, editing the content of Fragment 3, and then saving the file to the storage media. Since Fragment 4 was not changed between versions of the file, Fragment 4 is maintained. However, new Fragment 5′ includes an edited version of Fragment 3.

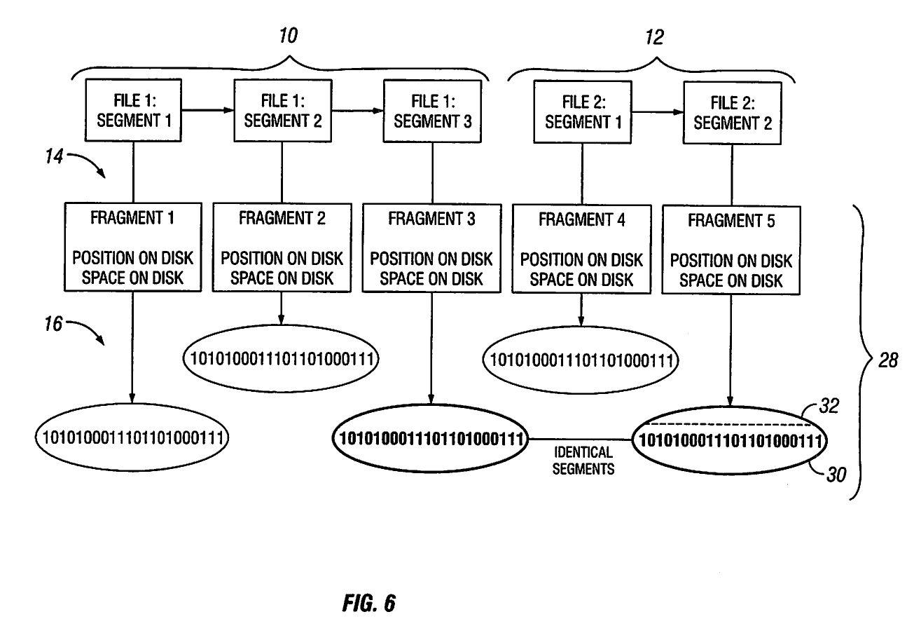

FIG. 6 is a schematic diagram of the data segments of first and second data files having identified that the end data portion 30 of new Fragment 5′ (shown at 28) is identical to Fragment 3. Therefore, the Fragment Manager has identified that the single Fragment 5′ could be divided into an end data portion 30 and a beginning data portion 32.

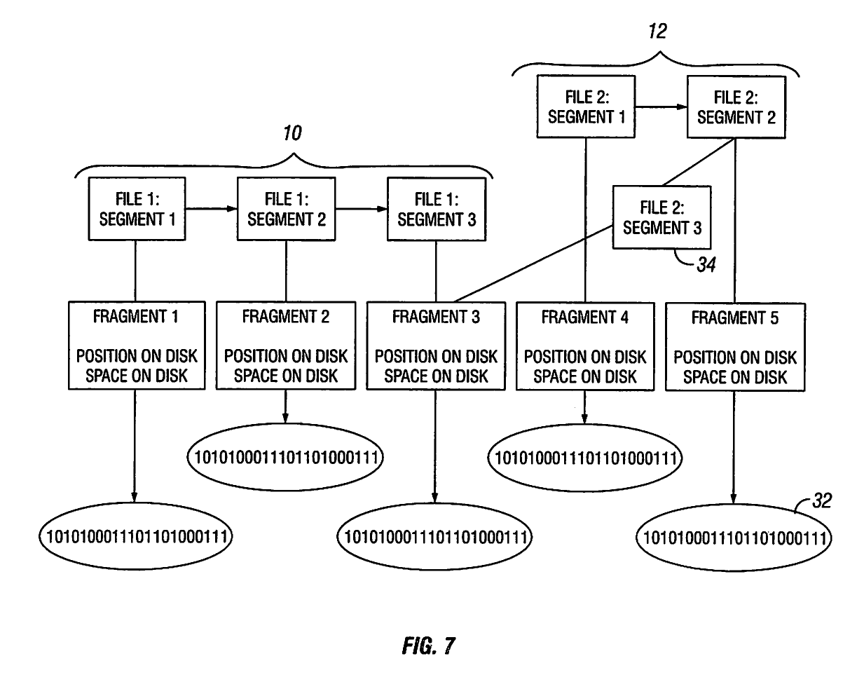

FIG. 7 is a schematic diagram of the data segments of first and second data files having modified the header 12 in File 2 to: (1) associate File 2, Segment 2 with a new or modified Fragment 5″ that includes only the unique data portion 32 Fragment, and (2) to reflect the creation of a new file header listing for File 2, Segment 3 (shown at 34) that is associated with Fragment 3, which is now again shared. Having made these two modifications, the end data portion (identified as end portion 30 in FIG. 6) has been reclaimed.

In order for the method of identifying identical data segments to work efficiently, there must exist an extremely quick method for comparing two streams of data to determine the similarities within the streams. This method preferably does not include an exact bit-by-bit comparison of the entire streams, because such a process would be extremely expensive and time-consuming. Instead, it is preferable to use a Data Duplication Search Algorithm that reads in two data streams once and gathers enough information about the two streams to identify the similarities.

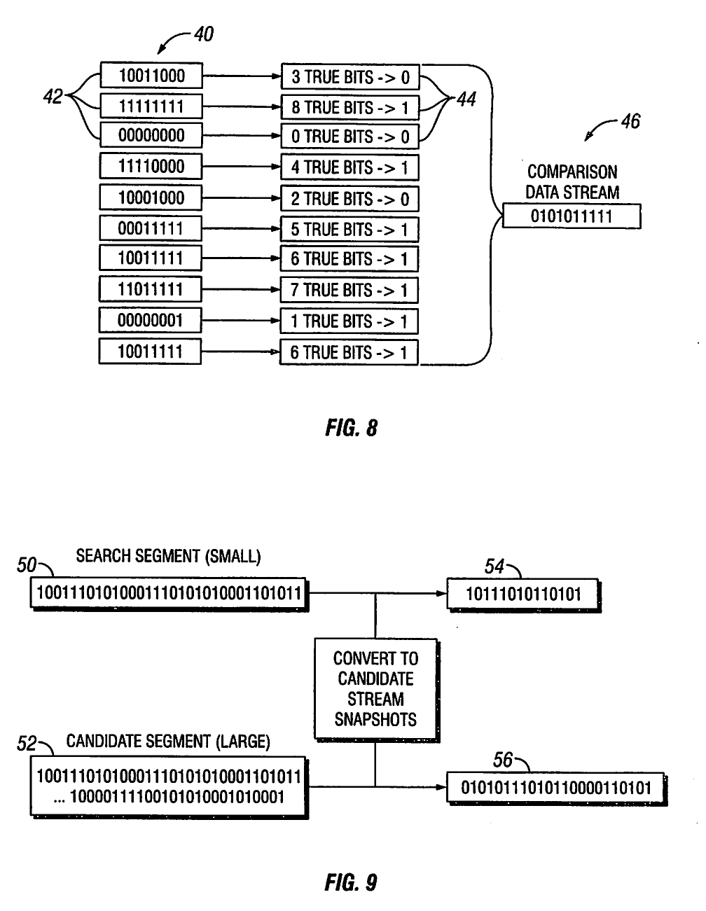

FIG. 8 is a schematic diagram of a method of forming a comparison data stream. A comparison stream is a stream of data where a single bit represents information about a block of bits. For this example, a single bit will represent a single byte. Therefore, a file that is 1000 bytes long would have a comparison stream 1000 bits long. The non-limiting example of an algorithm for producing a comparison stream, as shown in FIG. 8, reads each byte 42 in a file 40 and produces a return bit 44 of “1” if the byte has four or more “1”s, but otherwise produces a return bit of “0”. The resulting string of bits 44 forms a first comparison stream 46 that represents the file 40. This process is also performed for a second file in order to prepare a second comparison stream.

The benefit of comparing two comparison streams instead of doing a bit-by-bit comparison of the two entire data streams, is that the comparison is much less intensive. The comparison of the two comparison streams means comparing one bit per block of data, rather than all of the bits within each block of data. If a sequence of bits between the two comparison streams match, then these sequences of the streams are similar and we can further investigate as to whether or not the data segments corresponding to the matched sequences are identical. That further investigation involves a bit-by-bit comparison of the two data segments. The use of comparison streams in this manner is very beneficial for comparing large streams of data.

For example, a comparison stream is prepared for a data stream A that is 8 bytes long and a data stream B that is 10 bytes long. If comparison stream A did not match the first 8 bits of comparison stream B, then they are not identical (therefore we only compare 8 bits instead of 64). After that comparison, comparison stream A is compared against bits 1 through 9 of comparison stream B. If there is not a match, then the comparison stream A is shifted one bit relative to comparison stream B and the comparison is repeated. This process of comparing and then shifting is iterated until the comparison stream A has been compared to all positions within comparison stream B.

FIG. 9 is a schematic diagram illustrating how two comparison data streams 50, 52 are converted to snapshots 54, 56 for purpose of comparison. The snapshots are smaller and require less data to be read in to memory at one time. It is preferable to compare a small search segment 50 against a larger candidate segment 52 or, similarly, a small stream snapshot 54 against a larger candidate segment 56.

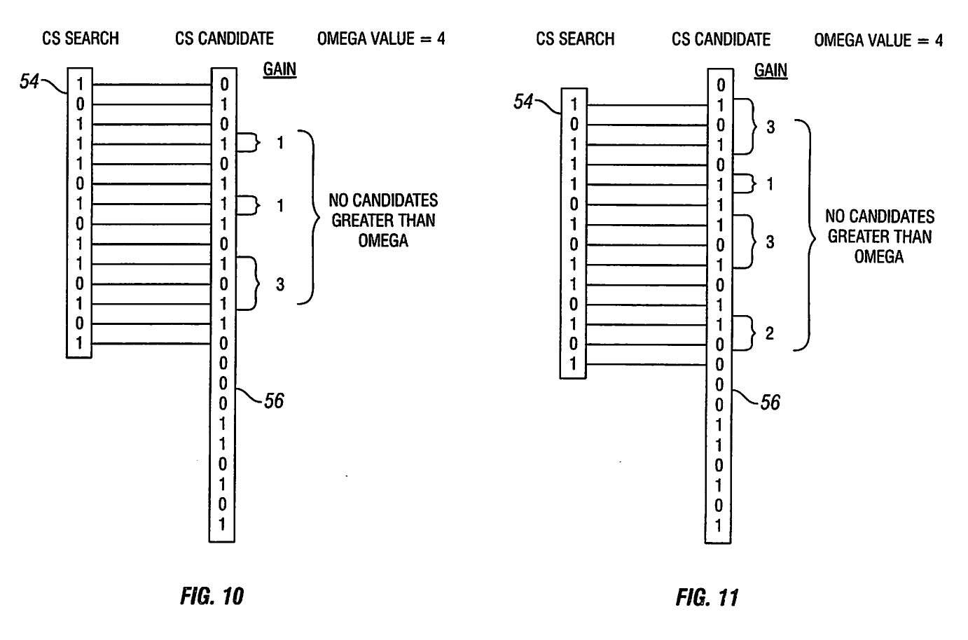

FIGS. 10-14 are schematic diagrams that show a sequence of steps for comparing the two comparison data streams 50, 52. In FIG. 10, the first and subsequent bits of the first comparison data stream 54 are sequentially compared with the first and subsequent bits of the second comparison data stream 56. The process of comparing the streams 54, 56 steps through the two streams one bit at a time and determines if bit values match. For example, in FIG. 10 the first three bits of stream 54 are “1-0-1” and the first three bits of stream 56 are “0-1-0.” Accordingly, there is no match in the first three bits of the comparison. While the fourth bit in both streams is a match (both have the value of “1”), the fifth bits do not match. Therefore, the process so far has found only a single matching “segment” of the comparison strings and that matching segment had a length or gain of only 1. Working through the two comparison strings, there is a matching bit of “1” at the seventh bit and a sequence of three matching bits “1-0-1” at the 10^{th} to 12^{th} bits. However, if the Omega value is set to 4 bytes, then the process has not yet found a candidate segment that would warrant a further bit-by-bit investigate because there are no sequences of matching comparison bits that exceeds the Omega value of 4.

FIG. 11 is a diagram of the same two comparison data streams 54, 56, but with the first bit and subsequent bits of stream 54 being sequentially compared to the second and subsequent bits of the comparison stream 56. While the process now finds four matching “segments”, these segments only have lengths of 3, 1, 3 and 2, respectively. Since there are still no matching comparison stream segments having a length greater than the Omega Value, a further bit-by-bit search on any of the matching segments is not warranted.

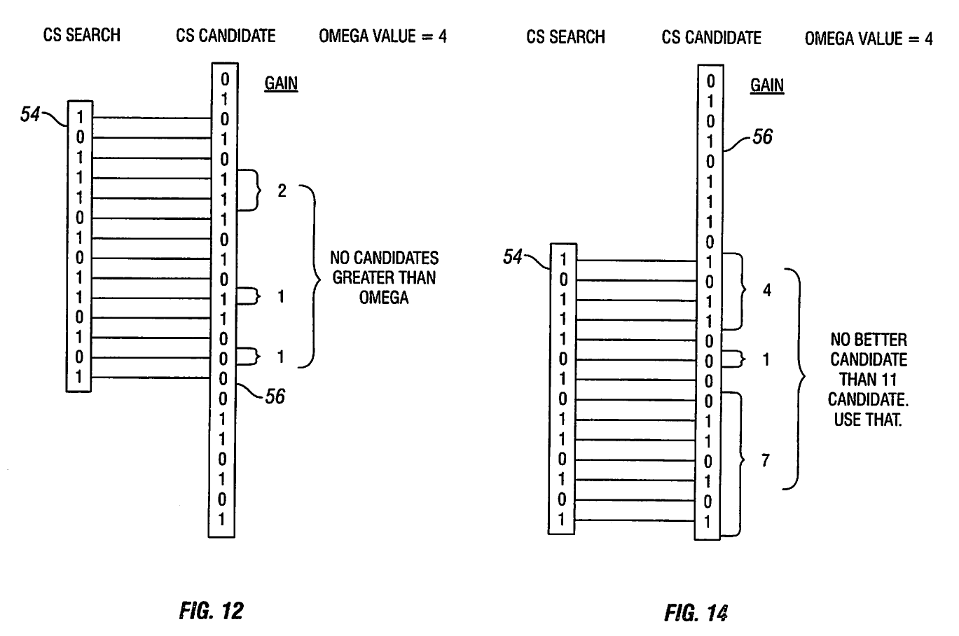

FIG. 12 is a diagram of the same two comparison data streams 54, 56, but with the first bit and subsequent bits of stream 54 being sequentially compared to the third and subsequent bits of the comparison stream 56. The process now finds three matching “segments” of lengths 2, 1 and 1, respectively. Since there are still no matching comparison stream segments having a length greater than the Omega Value, a further bit-by-bit search on any of the matching segments is not warranted.

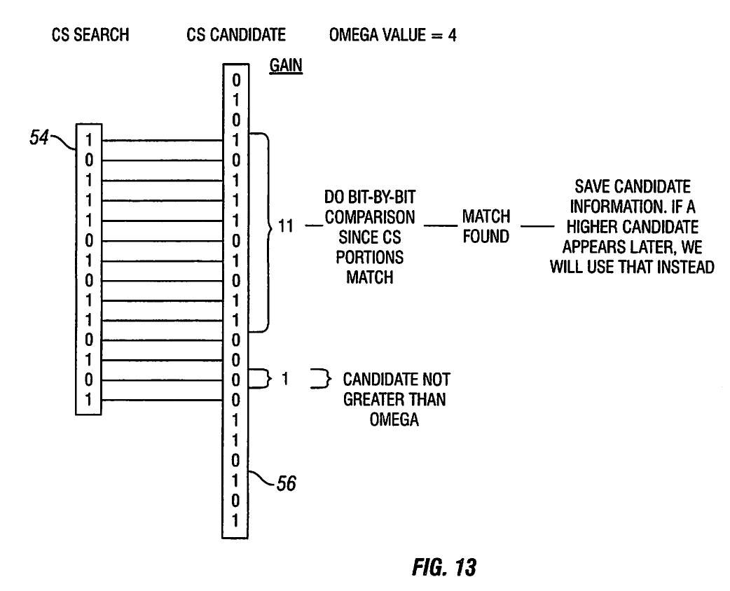

FIG. 13 is a diagram of the same two comparison data streams 54, 56, but with the first bit and subsequent bits of stream 54 being sequentially compared to the fourth and subsequent bits of the comparison stream 56. The process now finds two matching “segments” of lengths 11 and 1, respectively. The matching comparison stream segment having a length of 11 is greater than the Omega value of 4 and now warrants a further bit-by-bit search of the input data streams at the points in which the similarities were found. Accordingly, the first data stream from the 1^{st} to the 11^{th} byte will be compared bit-by-bit to the second data stream from the 4^{th} to the 14^{th} byte. If there are any bit-by-bit matches that exceed a sequential length of four bytes from within the eleven bytes being compared, then the candidate information should be saved. Otherwise, the candidate information may be discarded and the process of comparing data streams 54, 56 may continue.

FIG. 14 is a diagram of the same two comparison data streams 54, 56, but with the first bit and subsequent bits of stream 54 being sequentially compared to the tenth and subsequent bits of the comparison stream 56. The process now finds two matching “segments” of lengths 4, 1 and 7, respectively. However, none of these candidates are as long as the 11 bit candidate identified in FIG. 13. Accordingly, the 11 bit candidate is the largest identical segment of the two data stream and should be divided out into a shared fragment in a manner according to the present invention. While it is possible to divide out more than one identical segment from two data streams to provide two shared fragments, the 11 bit candidate (See FIG. 13) and the 7 bit candidate (See FIG. 14) cannot both form shared fragments in this instance (even assuming both candidates are shown to be bit-by-bit matches) because the two candidates rely upon overlapping portions of the first comparison data stream 54.

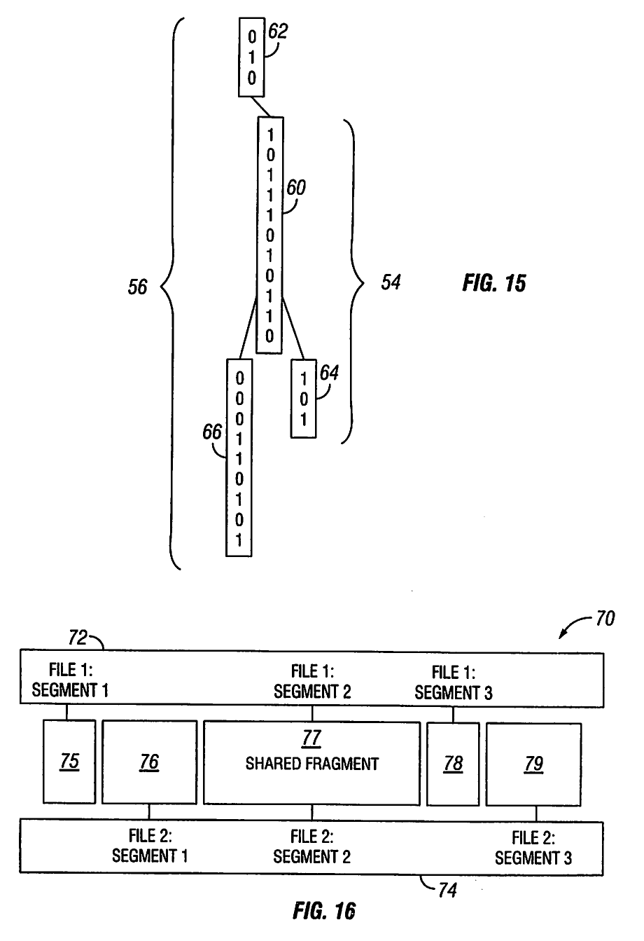

FIG. 15 is a schematic diagram of the relationship between the shared identical portion 60 of the two data streams and the unique portions 62, 64, 66 of the two data streams. The comparison stream 54 consists of the sequence including shared portion 60 and unique end portion 64. The comparison stream 56 consists of the sequence including unique beginning portion 62, shared portion 60, and unique end portion 66. While this diagram illustrates shared and unique portions of the comparison streams, this is intended only for the purposes of a simplified illustration. In actuality, it would be the full data stream (a full block of data for each of the comparison bits shown) that would be stored. However, the relationships of the fragments or portions 60, 62, 64, 66 would be the same.

This example would force the original two fragments (See FIGS. 10 to 14) to be broken out into the four fragments (See FIG. 15). Accordingly, the transition from two fragments to four fragments requires two additional file fragment headers. If each file header cost four bytes, this example would result in a net gain (reduction of disk usage) of three bytes by breaking the fragments out into shared sections. In reality, the shared segments should be much larger than the 11 bytes shown.

The methods of the present invention may be implemented in the form of a fragment manager that performs the task of searching for data duplication as described above. When identical segments are found, the fragment manager will perform the necessary breaking out of information into a shared fragment. That will require modifying the file headers of the relevant files in order form an association with the shared segment. One original segments identical to the shared fragment is now obsolete and may be reclaimed as free space on the storage media.

Breaking out the data into a shared fragment results in an inevitable increase of fragmentation. Modern hardware and software are able to minimize the impact of increased fragmentation. Disks with caches limit the impact of increased disk seeks. Software will also perform defragmentation to fuse fragments together, thus reducing the overall amount of disk searching needed. However, a defragmention process will benefit from the present invention by enabling the handling of shared fragments. It would be unwise to fuse a shared fragment back into its original stream, because the data would then again be duplicated (both data streams would each have a dedicated copy of the fragment again and no sharing would take place).

Another method for dealing with the inevitable increase of fragmentation brought about by the present invention includes storing the fragments in a manner that reduces the seek times between the various fragments. For example, the header and footer fragments of each stream may be wrapped around the shared fragment. That way, we know that the shared fragment is found shortly after the header fragment. We would also know that the footer fragment is found shortly after the shared fragment. By doing this, the seek distance between the fragments is greatly reduced.

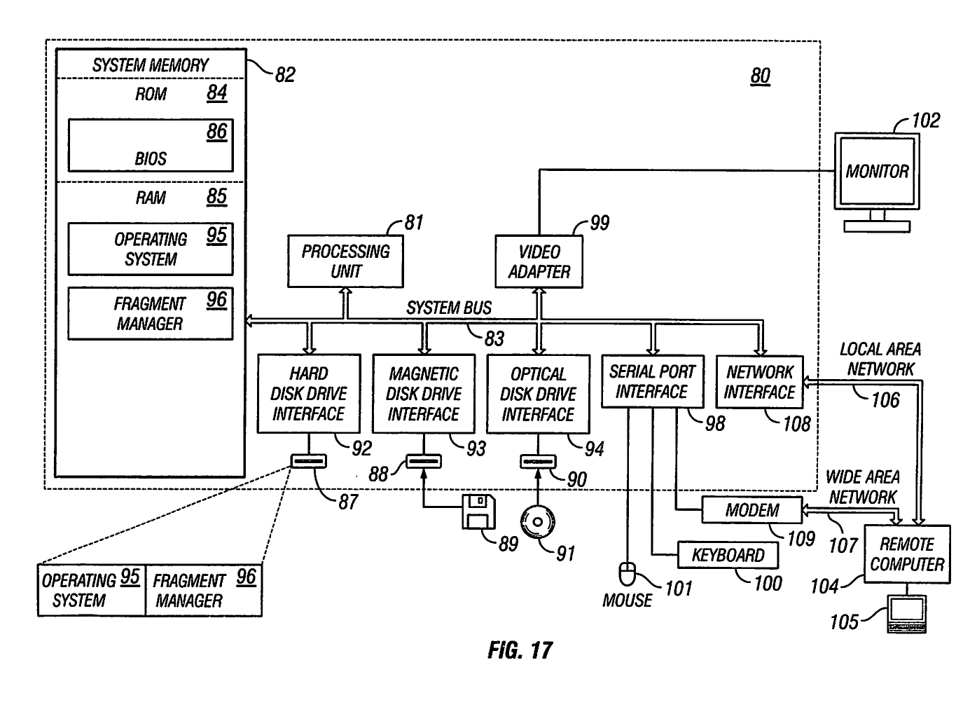

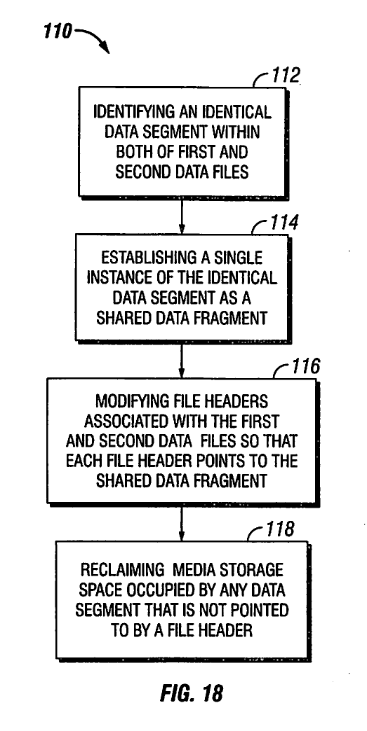

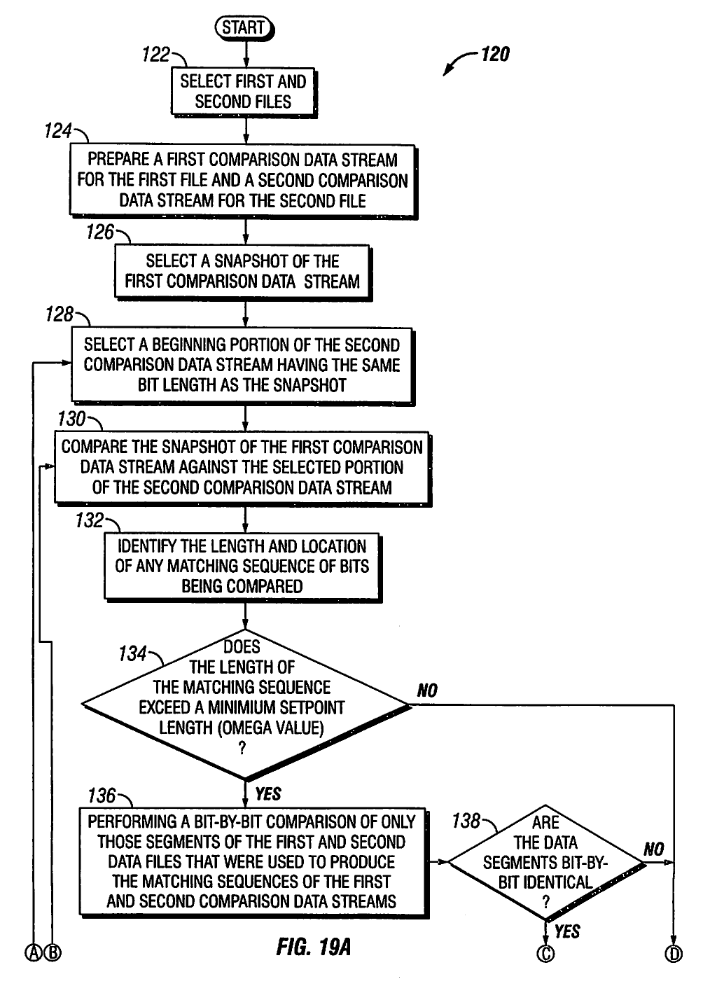

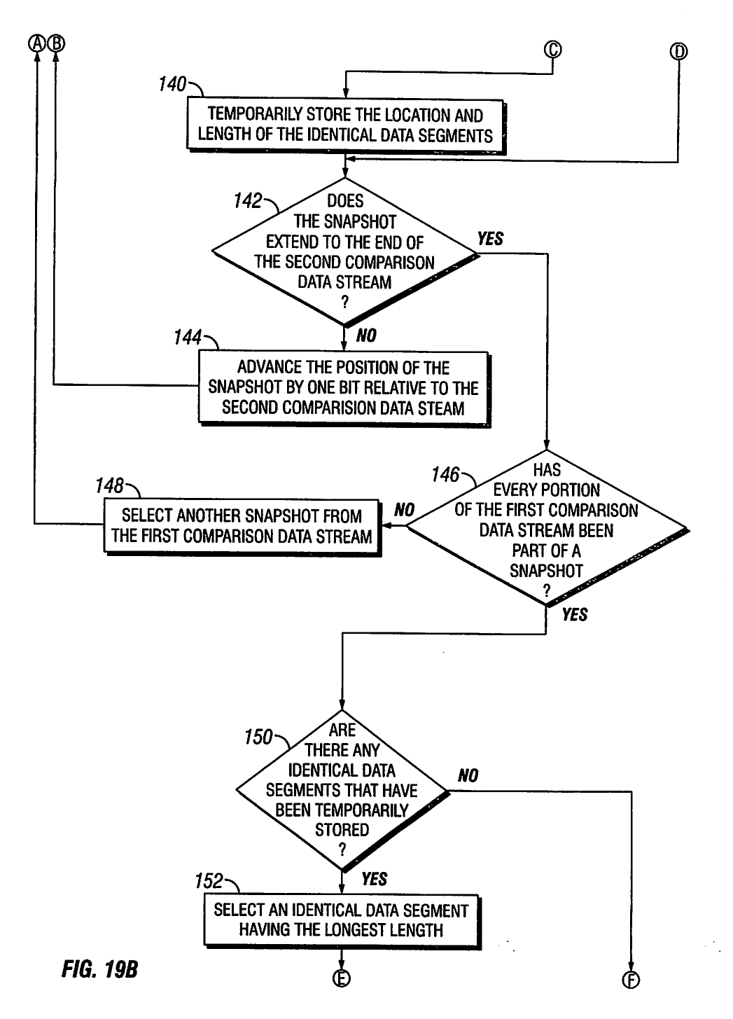

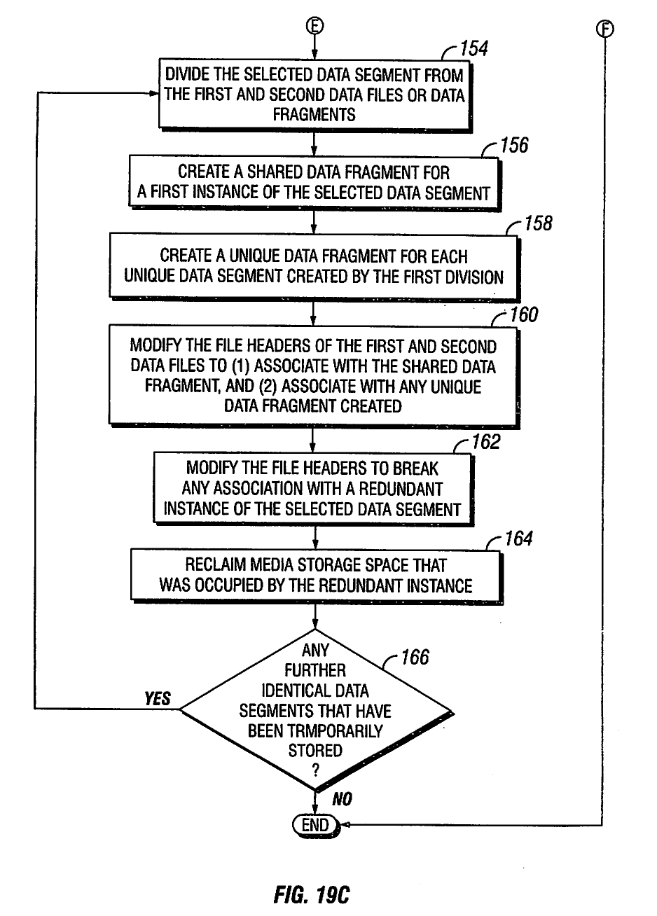

FIG. 16 is a schematic diagram of a preferred arrangement 70 for storing the unique fragments of two files in relation to a fragment shared by the two files. This shows how various fragments might be organized by a shared data defragmentation process. Accordingly, a File 1 includes a file header 72 associating with three fragments 75, 77, 78 and a File 2 includes a file header 74 associating with three fragments 76, 77, 79. If File 1 was being read into memory, the hardware would read fragment 75 (File 1: Segment 1), then skip the length of fragment 76 (File 2: Segment 1) which is a very short distance (and therefore quicker). Then, the hardware would read the shared fragment 77 (because it is associated with File 1: Segment 2), followed immediately by fragment 78 (File 1: Segment 3). The three fragments of File 2 could be read in a similar manner. Intermingling the fragments that make up the two files will minimize the searches that are needed on the disk. Notice that only two disk seeks are required to read either of the two files.

The present methods are also beneficial when copying a file from one location to another on the same disk. A copy operation can be performed by creating a second file whose file header associated with all of the same fragments as the first file. This would enable nearly instant creation of file copies that only require storage space for the new file header.

FIG. 17 is a schematic diagram of a computer system 80 that is capable of running a browser. The system 80 may be a general-purpose computing device in the form of a conventional personal computer 80. Generally, a personal computer 80 includes a processing unit 81, a system memory 82, and a system bus 83 that couples various system components including the system memory 82 to processing unit 81. System bus 83 may be any of several types of bus structures including a memory bus or memory controller, a peripheral bus, and a local bus using any of a variety of bus architectures. The system memory includes a read-only memory (ROM) 84 and random-access memory (RAM) 85. A basic input/output system (BIOS) 86, containing the basic routines that help to transfer information between elements within personal computer 80, such as during start-up, is stored in ROM 84.

Computer 80 further includes a hard disk drive 87 for reading from and writing to a hard disk 87, a magnetic disk drive 88 for reading from or writing to a removable magnetic disk 89, and an optical disk drive 90 for reading from or writing to a removable optical disk 91 such as a CD-ROM or other optical media. Hard disk drive 87, magnetic disk drive 88, and optical disk drive 90 are connected to system bus 83 by a hard disk drive interface 92, a magnetic disk drive interface 93, and an optical disk drive interface 94, respectively. Although the exemplary environment described herein employs hard disk 87, removable magnetic disk 89, and removable optical disk 91, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for computer 80. For example, the operating system 95 and application programs, such as a fragment manager 96, may be stored in the RAM 85 and/or hard disk 87 of the computer 80.

A user may enter commands and information into personal computer 80 through input devices, such as a keyboard 100 and a pointing device, such as a mouse 101. Other input devices (not shown) may include a microphone, joystick, game pad, satellite dish, scanner, or the like. These and other input devices are often connected to processing unit 81 through a serial port interface 98 that is coupled to the system bus 83, but input devices may be connected by other interfaces, such as a parallel port, game port, a universal serial bus (USB), or the like. A display device 102 may also be connected to system bus 83 via an interface, such as a video adapter 99. In addition to the monitor, personal computers typically include other peripheral output devices (not shown), such as speakers and printers.

The computer 80 may operate in a networked environment using logical connections to one or more remote computers 104. Remote computer 104 may be another personal computer, a server, a client, a router, a network PC, a peer device, a mainframe, a personal digital assistant, an Internet-connected mobile telephone or other common network node. While a remote computer 104 typically includes many or all of the elements described above relative to the computer 80, only a display device 105 has been illustrated in the figure. The logical connections depicted in the figure include a local area network (LAN) 106 and a wide area network (WAN) 107. Such networking environments are commonplace in offices, enterprise-wide computer networks, intranets, and the Internet.

When used in a LAN networking environment, the computer 80 is often connected to the local area network 106 through a network interface or adapter 108. When used in a WAN networking environment, the computer 80 typically includes a modem 109 or other means for establishing high-speed communications over WAN 107, such as the Internet. A modem 109, which may be internal or external, is connected to system bus 83 via serial port interface 98. In a networked environment, program modules depicted relative to personal computer 80, or portions thereof, may be stored in the remote memory storage device 105. It will be appreciated that the network connections shown are exemplary and other means of establishing a communications link between the computers may be used. A number of program modules may be stored on hard disk 87, magnetic disk 89, optical disk 91, ROM 84, or RAM 85, including an operating system 95 and fragment manager 96.

The described example of a computer system does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

FIG. 18 is a flowchart of the basic steps of a method 110 for managing data fragments. The method begins by identifying an identical data segment within both of first and second data files in step 112. The next step 114 establishes a single instance of the identical data segment as a shared data fragment. File headers associated with the first and second data files are then modified, in step 116, so that each file header points to the shared data fragment. The media storage space occupied by any data segment that is no longer associated with a file header may be reclaimed in step 118.

FIGS. 19A-C provide a detailed flowchart of a method 120 in accordance with one embodiment of the invention. In step 122, first and second files are selected for comparison. Step 124 includes preparing a first comparison data stream for the first file and a second comparison data stream for the second file. A snapshot of the first comparison data stream is then selected in step 126 and a beginning portion of the second comparison data stream having the same bit length as the snapshot is selected in step 128.

In step 130, the snapshot of the first comparison data stream is compared against the selected portion of the second comparison data stream. This allows the identification, in step 132, of the length and location of any matching sequence of bits being compared. If it is determined, in step 134, that the length of the matching sequence exceeds a minimum setpoint length (Omega value), then step 136 performs a bit-by-bit comparison of only those data segments of the first and second data files that were used to produce the matching sequences of the first and second comparison data streams. Then if the data segments are determined to be bit-by-bit identical in step 138, then step 140 temporarily stores the location and length of the identical data segments. A determination in step 134 that the matching sequence is less than or equal to the Omega value or a determination in step 138 that the data segments are not bit-by-bit identical, moved the process directly to step 142.

Step 142 determines if the current snapshot extends to the end of the second comparison data stream. If the snapshot does not so extend, then step 144 advances the position of the snapshot by one bit relative to the second comparison data stream before returning the process to step 130 to begin the comparison at a new location. However, if the snapshot does extend to the end of the second comparison data stream, then step 146 determines whether every portion of the first comparison data stream been part of a snapshot. If there is a portion that has not been part of snapshot for comparison, then step 148 selects another snapshot from the first comparison data stream before returning the process to step 128 to begin a comparison of the new snapshot. However, if the entire comparison data stream has been part of a snapshot for comparison, then in step 150 it is determined whether there any identical data segments that have been temporarily stored (as in step 140). If there are no identical data segments, then the process ends. However, if identical data segments were previously identified, then step 152 selects the identical data segment having the longest length. Step 154 divides the selected data segment from the first and second data files or data fragments. Step 156 then creates a shared data fragment for a first instance of the selected data segment and step 158 creates a unique data fragment for each unique data segment created by the division. Step 160 modifies the file headers of the first and second data files to (1) associate with the shared data fragment, and (2) associate with any unique data fragment created, and step 162 modifies the file headers to break any association with a redundant instance of the selected data segment. In step 164, media storage space that was occupied by the redundant instance is reclaimed. Reference to reclaiming the storage space is intended to include actual deletion of the data or simply no longer protecting the data from being deleted. If any further identical data segments that have been temporarily stored in step 166, then the process returns to step 154 to divide out another data segment. When no more identical data segments are present, then the process ends. Alternatively, the process may end after a certain number of shared fragments are created. The Omega value may be increased in order to limit the number of shared data fragments that the process will create.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

What is claimed is:

1. A method of managing data fragments, comprising:
identifying identical instances of a data segment within both of first and second data files;
establishing one of the identical instances as a shared data fragment;
modifying file headers of the first and second data files so that each file header associates with the shared data fragment and does not associate with a redundant instance of the data segment; and
reclaiming storage media space occupied by any data segment that is no longer associated with a file header.

2. The method of claim 1, further comprising:
executing a copy command by establishing the second data file with a file header that points to the same data fragments as the first file header.

3. The method of claim 1, further comprising:
identifying any unique data segment within either of the first and second data files;
establishing each unique data segment as a dedicated data fragment; and
modifying file headers associated with either of the first and second data files so that each file header points to any dedicated data fragment that is part of the associated data file.

4. The method of claim 1, wherein the step of determining that first and second data files include an identical data segment and at least one unique data segment, comprising the steps of:
producing a data stream associated with each of the first and second data files, each data stream comprising the output of an algorithm that produces a representative bit for each of sequence of bytes in the data file; and then
identifying portions of the data stream associated with the first data file containing a sequence of bits in common with the data stream associated with the second data file, wherein the sequence of bits exceeds a certain minimum sequence length;
performing a bit-by-bit comparison of only those segments of the first and second data files that were used to produce the identical portions of the data streams; and then
identifying an identical data segment as that segment of the first and second data files that are bit-by-bit identical.

5. The method of claim 4, wherein the step of identifying identical portions of the data stream includes an iterative process of comparing a search fragment against a candidate fragment, then advancing the position of the search fragment by one bit relative to the second candidate fragment.

6. The method of claim 1, further comprising:
determining whether the identical data segment has a length greater than a set point length.

7. The method of claim 6, wherein the set point length is a fixed value.

8. The method of claim 6, wherein the set point is a value calculated as a function of additional file header segment storage lengths necessary to accommodate reclaiming one of the identical data segments.

9. The method of claim 3, further comprising:
storing the unique segments of the first and second data files adjacent the shared data segment, wherein the unique segments of the first and second data files are maintained in sequence relative to the shared data segment.

10. The method of claim 9, wherein the unique data segments of the first and second data files are intermingled.

11. The method of claim 1, wherein the first and second data files each include a file header that points to all of the data fragments associated with the data file.

12. The method of claim 11, wherein the each data fragment includes a data fragment header.

13. A computer program product including instructions embodied on a computer readable medium for managing data fragments, the instructions comprising:
instructions for identifying identical instances of a data segment within both of first and second data files;
instructions for establishing one of the identical instances as a shared data fragment;
instructions for modifying file headers of the first and second data files so that each file header associates with the shared data fragment and does not associate with a redundant instance of the data segment; and
instructions for reclaiming storage media space occupied by any data segment that is no longer associated with a file header.

14. The computer program product of claim 13, further comprising:
instructions for executing a copy command by establishing the second data file with a file header that points to the same data fragments as the first file header.

15. The computer program product of claim 13, further comprising:
instructions for identifying any unique data segment within either of the first and second data files;
instructions for establishing each unique data segment as a dedicated data fragment; and
instructions for modifying file headers associated with either of the first and second data files so that each file header points to any dedicated data fragment that is part of the associated data file.

16. The computer program product of claim 13, wherein the instructions for determining that first and second data files include an identical data segment and at least one unique data segment, further comprise:
instructions for producing a data stream associated with each of the first and second data files, each data stream comprising the output of an algorithm that produces a representative bit for each of sequence of bytes in the data file;
instructions for identifying portions of the data stream associated with the first data file containing a sequence of bits in common with the data stream associated with the second data file, wherein the sequence of bits exceeds a certain minimum sequence length;
instructions for performing a bit-by-bit comparison of only those segments of the first and second data files that were used to produce the identical portions of the data streams; and
instructions for identifying an identical data segment as that segment of the first and second data files that are bit-by-bit identical.

17. The computer program product of claim 13, further comprising:
instructions for determining whether the identical data segment has a length greater than a set point length.

18. The computer program product of claim 17, wherein the set point length is a value calculated as a function of additional file header segment storage lengths necessary to accommodate reclaiming one of the identical data segments.

19. The computer program product of claim 15, further comprising:
instructions for storing the unique segments of the first and second data files adjacent the shared data segment, wherein the unique segments of the first and second data files are maintained in sequence relative to the shared data segment.

20. The computer program product of claim 19, wherein the unique data segments of the first and second data files are intermingled.

21. A method of comparing first and second data fragments, comprising the steps of:
producing a comparison data stream associated with each of the first and second data files, each data stream comprising the output of an algorithm that produces a representative bit for each block of data in the data file;
identifying portions of the comparison data stream associated with the first data file that contains a sequence of representative bits that is identical with a sequence of representative bits contained in the comparison data stream associated with the second data file, wherein the identical sequence of representative bits exceeds a certain minimum sequence length;
performing a bit-by-bit comparison of only those segments of the first and second data files that were used to produce the identical sequences of the comparison data streams; and
identifying an identical data segment as that segment of the first and second data files that are bit-by-bit identical.

22. The method of claim 21, wherein the step of identifying identical portions of the comparison data streams includes an iterative process of comparing a search fragment against a candidate fragment, then advancing the position of the search fragment by one bit relative to the second candidate fragment.

23. The method of claim 21, wherein the data fragments are data files.

24. The method of claim 21, wherein the block of data is a byte or group of bytes.
